(19) United States
(12) Patent Application Publication
(10) Pub. No.: US 2026/0119551 A1
(43) Pub. Date: Apr. 30, 2026

(54) DYNAMIC AND ADAPTIVE SEMANTIC GUARDRAIL EXPANSION FOR ARTIFICIAL INTELLIGENCE (AI) AGENTS

(71) Applicant: BOOMI, LP, Conshohocken, PA (US)

(72) Inventors: Ayush PARASHAR, Foster City, CA (US); Lomesh AGRAWAL, Bangalore (IN); Swagata ASHWANI, San Francisco, CA (US); Rishabh AWATANI, Toronto (CA)

(73) Assignee: BOOMI, LP, Conshohocken, PA (US)

(21) Appl. No.: 19/366,971

(22) Filed: Oct. 23, 2025

(30) Foreign Application Priority Data
Oct. 25, 2024 (IN) 202411081537
Oct. 25, 2024 (IN) 202411081538

(51) Int. Cl. G06F 16/334; G06F 16/31

(52) U.S. Cl. CPC G06F 16/3344; G06F 16/316

(57) ABSTRACT

Conventionally, guardrails for artificial intelligence (AI) agents are static and rigid. As language usage evolves, these guardrails must be manually updated, which has become impractical as the number of AI agents has increased exponentially in recent years. Accordingly, disclosed embodiments provide automated semantic and context-aware expansion of agentic guardrails. In particular, base guardrails may be decomposed into base guardrail elements. The base guardrail elements may be semantically expanded into similar guardrail elements, for which context markers may be generated. New guardrails may be generated by combining these semantically similar guardrail elements with context markers, and these expanded guardrails may be incorporated into the AI agent.

### CROSS-REFERENCE TO RELATED APPLICATIONS

The present application claims priority to Indian Patent Application No. 202411081537, filed on Oct. 25, 2024, and Indian Patent Application No. 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to dynamic and adaptive semantic guardrail expansion for AI agents.

### Description of the Related Art

A number of platforms exist that enable users to develop and manage artificial intelligence (AI) agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

Each AI agent may be subject to one or more guardrails. A guardrail is any constraint or control on an AI agent that is designed to ensure that the AI agent behaves safely, securely, ethically, and/or within intended boundaries. In particular, a guardrail may enforce a limit on what the AI agent can do, say, or decide, so as to prevent undesired outcomes, such as harmful actions, security breaches, or policy violations, by restricting the behavior of the AI agent.

There are different types of guardrails. For example, policy guardrails define acceptable behaviors for the AI agent, such as avoiding personal data collection or disallowed topics. Operational guardrails define system-level constraints on actions of the AI agent, such as limiting access to external application programming interfaces, databases, or hardware controls. Ethical guardrails define principles that ensure fairness, transparency, and the avoidance of bias by the AI agent. Safety guardrails prevent dangerous or irreversible actions by the AI agent, for example, by requiring human-in-the-loop confirmations for certain actions. Cybersecurity guardrails govern how the AI agent handles data, accesses data, and/or interacts with data, users, and/or other software entities, to prevent unauthorized data access, use, and/or modification. A cybersecurity guardrail may define what data the AI agent can access, process, store, and share, as well as how the AI agent performs authentication, logs events, and responds to security-related events. It should be understood that these are just a few examples of the types of guardrails that may apply to AI agents.

Existing guardrails for AI agents typically rely on static lists of keywords, phrases, or predefined rules, to filter content and detect potential misuse of the AI agents. These guardrails struggle, due to limited coverage (e.g., missing variations of prohibited content), lack of contextual awareness (e.g., an inability to distinguish appropriate or inappropriate uses of similar language in different contexts), and rigidity (e.g., requiring frequent manual updates).

### SUMMARY

Accordingly, systems, methods, and non-transitory computer-readable media are disclosed for dynamic and adaptive semantic guardrail expansion for AI agents.

In an embodiment, a method comprises using at least one hardware processor to, for each of one or more artificial intelligence (AI) agents, performing a guardrail expansion that comprises: receiving one or more base guardrails of the AI agent, wherein each of the one or more base guardrails comprises one or more base guardrail elements; identifying one or more similar guardrail elements that are each semantically similar, according to a similarity metric, to at least one of the one or more base guardrail elements of the one or more base guardrails; generating one or more context markers based on one or more contexts that are applicable to the AI agent; generating one or more new guardrails based on the one or more similar guardrail elements and the one or more context markers; and incorporating one or more expanded guardrails that comprise the one or more new guardrails into the AI agent.

The one or more expanded guardrails may be a plurality of guardrails that comprises the one or more base guardrails and the one or more new guardrails.

The one or more base guardrail elements may comprise one or more first keywords, wherein the one or more similar guardrail elements comprise one or more second keywords that are different from the one or more first keywords. At least one of the one or more new guardrails may comprise a rule that activates the at least one guardrail when the one or more second keywords are present within an input to the AI agent or an output generated by the AI agent.

Identifying the one or more similar guardrail elements may comprise, for each of the one or more base guardrail elements: converting the base guardrail element into an input embedding vector; searching a vector database for one or more matching reference embedding vectors that are semantically similar, according to the similarity metric, to the input embedding vector; and identifying each guardrail element that is associated with one of the one or more matching reference embedding vectors as one of the one or more similar guardrail elements.

Generating the one or more context markers may comprise, for each of the one or more similar guardrail elements, for each of the one or more contexts: determining a sentiment of the similar guardrail element within the context; and determining whether or not the similar guardrail element is appropriate for the context based on the determined sentiment. The one or more contexts may comprise a plurality of contexts. For each of the one or more similar guardrail elements, the one or more contexts may comprise a context of the at least one base guardrail element to which the similar guardrail element is semantically similar. For each of the one or more similar guardrail elements, the one or more contexts may comprise a context retrieved from a library of contexts.

Generating the one or more context markers may comprise, for each of the one or more similar guardrail elements, generating a context marker for each of the one or more contexts for that similar guardrail element. Generating the one or more new guardrails may comprise, for each of at least a subset of the one or more similar guardrail elements, generating a rule that combines the similar guardrail element with at least one of the one or more context markers.

The method may further comprise using the at least one hardware processor to, for each of a plurality of AI agents, store the one or more base guardrails and the one or more expanded guardrails, in association with an identifier of the AI agent, within an expansion database.

The identification of the one or more similar guardrail elements may be performed by a semantic-analysis engine, the generation of the one or more context markers may be performed by a context-evaluation module, the generation of the one or more new guardrails may be performed by a dynamic-rule generator, and the method may further comprise using the at least one hardware processor to: for each of at least a subset of the one or more AI agents, during execution of the AI agent, receive feedback for at least one interaction between the AI agent and an end user; and update one or more of the semantic-analysis engine, context-evaluation module, or dynamic-rule generator, based on the feedback. The method may further comprise determining one or both of one or more false positives or one or more false negatives based on the feedback, wherein each of the one or more false positives represents an activation of at least one of the one or more expanded guardrails when that at least one expanded guardrail should not have been activated, wherein each of the one or more false negatives represents a failure to activate any of the one or more expanded guardrails when at least one of the one or more expanded guardrails should have been activated, and wherein the update to one or more of the semantic-analysis engine, context-evaluation module, or dynamic-rule generator is based on the one or both of the one or more false positives or the one or more false negatives.

Identifying one or more similar guardrail elements may comprise, for each of the one or more base guardrail elements, identifying one or more similar guardrail elements that are each semantically similar, according to the similarity metric, to that base guardrail element. Generating the one or more context markers may comprise, for each of the one or more base guardrail elements, generating one or more context markers based on one or more contexts that are applicable to that base guardrail element. Generating the one or more new guardrails may comprise, combining each of the one or more similar guardrail elements with at least one of the one or more context markers, to generate a new filtering rule.

The guardrail expansion may be performed in real time during a session between the AI agent and an end user. The guardrail expansion may occur between a reception of an input by the AI agent from the end user and an application of guardrails of the AI agent to the input, such that the guardrails that are applied to the input include the one or more expanded guardrails. The one or more contexts may comprise a current context window of the AI agent from the session.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for dynamic and adaptive semantic guardrail expansion for AI agents, according to an embodiment; and

FIG. 4 illustrates an example process for dynamic and adaptive semantic guardrail expansion for AI agents, according to an embodiment.

### DETAILED DESCRIPTION

Embodiments of systems, methods, and non-transitory computer-readable media are disclosed for dynamic and adaptive semantic guardrail expansion for AI agents. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

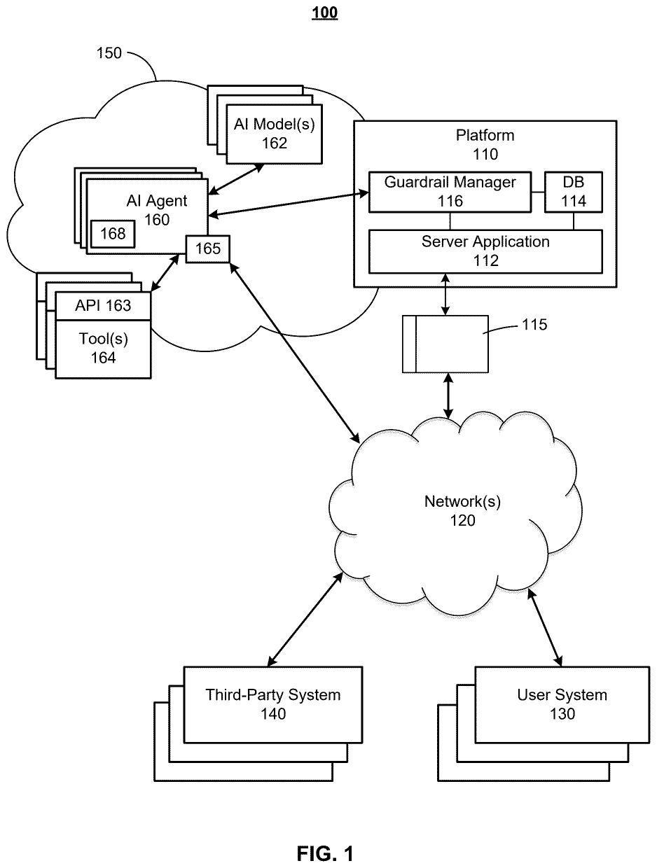

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112 and/or a guardrail manager 116. Platform 110 may also host a database 114 that may store data used and/or produced by server application 112 and/or guardrail manager 116. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user system 130 would be the personal computer or professional workstation of a developer or other manager of artificial intelligence (AI) agents 160, who has a user account for accessing server application 112 on platform 110. It should be understood that the user may be anywhere from an expert software engineer, with extensive knowledge of programming, to a business decision-maker, lay person, or other non-technical person, with little to no knowledge of programming. Each user account may be associated with an overarching organizational account for managing software entities, including AI agents 160.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112, guardrail manager 116, and/or other software entities in computing environment (e.g., AI Agents 160) in accordance with roles or permissions of the associated user account. The user may interact with server application 112, guardrail manager 116, and/or other software entities to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) within computing environment 150 may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each AI agent 160 and/or integration process, when deployed, may be communicatively coupled to network(s) 120. For example, each AI agent 160 and/or integration process may comprise an application programming interface (API) that enables clients to access the software entity via network(s) 120. For instance, AI agent 160 comprises an agentic interface 165 that may comprise or consist of an application programming interface. A client may push data to an AI agent 160 and/or integration process through the application programming interface, and/or pull data from AI agent 160 and/or an integration process through the application programming interface.

In some cases, an AI agent 160 may be a conversational AI agent. In this case, AI agent 160 may implement a chat interface, within agentic interface 165. The chat interface may be comprised or embedded (e.g., as an overlaid chat frame) within user interface 115. Alternatively, the chat interface may be separate and distinct from user interface 115. The chat interface may comprise a graphical user interface, an audio interface, or a combination of graphical and audio user interface (i.e., an audiovisual interface).

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

As discussed above, the software entities(s) being developed and/or otherwise managed on platform 110 may include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like. Although only a few AI agents 160 are illustrated, it should be understood that computing environment 150 may comprise any number of AI agents 160, including hundreds, thousands, tens of thousands, hundreds of thousands, millions, tens of millions, hundreds of millions, billions, tens of billions, hundreds of billions, or more AI agents 160. For the sake of simplicity, an AI agent 160 may also be referred to herein simply as an “agent,” and the term “agentic” is an adjective that indicates that the modified noun pertains to an AI agent 160.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney from Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to herein as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

Each AI agent 160 may be subject to one or more guardrails 168. As discussed above, a guardrail 168 is any constraint or control on AI agent 160 that is designed to ensure that AI agent 160 behaves safely, securely, ethically, and/or within intended boundaries. Conventionally, the guardrail(s) 168 for AI agent 160 are implemented as static rules that apply filters (e.g., keyword filters) to the input of AI agent 160, output of AI agent 160, one or more decisions in the decision-making process of AI agent 160, one or more calls to AI model 162, one or more calls to tool(s) 164, and/or the like. For instance, AI agent 160 may apply guardrail(s) 168, pertaining to inputs, to each input that is submitted to AI agent 160, before responding to that input, and may apply guardrail(s) 168, pertaining to outputs, to each output (e.g., of AI model 162) before returning the output to the requesting entity (e.g., an end user or software entity). When the static rule(s) are satisfied, the respective guardrail 168 is activated to perform a remedial action. The remedial action may comprise blocking an input, output (e.g., response to the input), model call, tool call, or the like, blocking a data access or communication, terminating execution of AI agent 160, initiating reinforcement learning with human feedback (RLHF) to align the behavior of AI agent 160 with human-approved norms, and/or the like. A false positive refers to the activation of a guardrail 168 in an instance in which that guardrail 168 should not have been activated, whereas a false negative refers to the failure to activate a guardrail 168 in an instance in which that guardrail 168 should have been activated.

### 2. Example Processing System

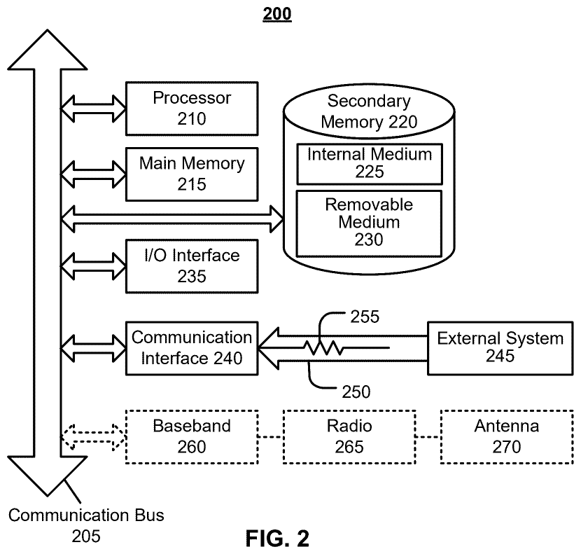

FIG. 2 illustrates an example processing system 200, by which one or more of the processes described herein may be executed, according to an embodiment. For example, system 200 may be used to store and/or execute server application 112, guardrail manager 116, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic,. NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Data Flow

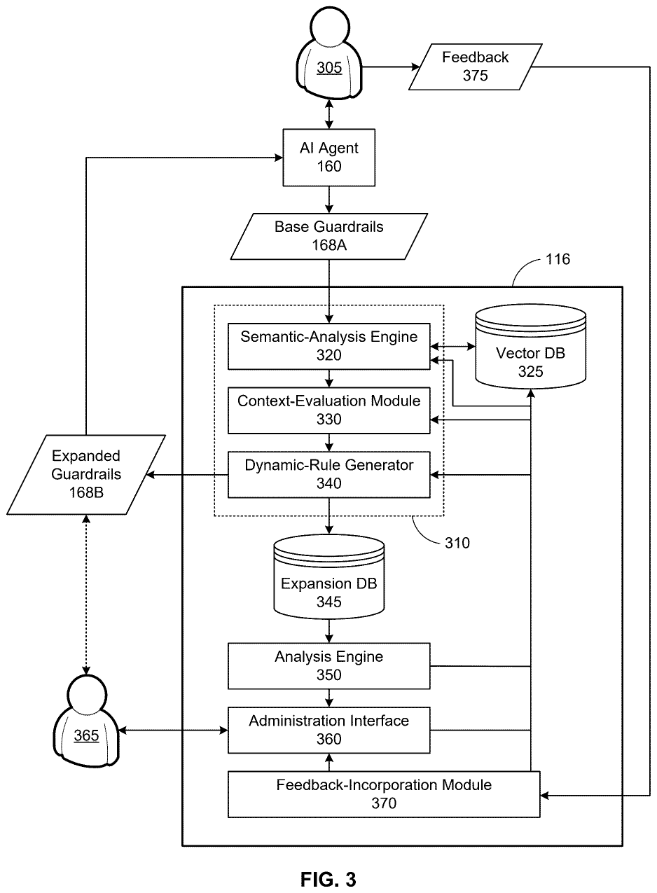

FIG. 3 illustrates an example data flow 300 for dynamic and adaptive semantic guardrail expansion for AI agents 160, according to an embodiment. Data flow 300 may be implemented by guardrail manager 116. Guardrail manager 116 may be a software module of server application 112, or may be a software entity that is separate from server application 112, but which may be communicatively coupled to server application 112. As an example of the latter, guardrail manager 116 may itself be an AI agent 160, which utilizes one or more AI models 162 and/or tools 164 to perform or aid in the disclosed functions. Guardrail manager 116 may comprise an expansion module 310, which comprises a semantic-analysis engine 320, a context-evaluation module 330, and a dynamic-rule generator 340. Guardrail manager 116 may also comprise an analysis engine 350, an administration interface 360, and/or a feedback-incorporation module 370. In addition, guardrail manager 116 may comprise or be communicatively coupled to a vector database 325 (e.g., stored in database 114) that is utilized by semantic-analysis engine 320, and/or an expansion database 345 (e.g., stored in database 114) that is populated by dynamic-rule generator 340 and utilized by analysis engine 350.

AI agent 160 may provide one or more base guardrails 168A to expansion module 310. In an embodiment, AI agent 160 provides base guardrail(s) 168A directly to expansion module 310, while AI agent 160 is executing within computing environment 150. For example, AI agent 160 may provide base guardrail(s) 168A to expansion module 310, in real time, during a session between AI agent 160 and an end user 305, in either a production environment or test environment. As used herein, the terms “real time” and “real-time” refer both to events that occur simultaneously and events that are temporally separated from each other by ordinary latencies in processing, memory access, communications, and/or the like, and includes those events that are sometimes referred to as “near real-time” events. Alternatively, AI agent 160 may provide base guardrail(s) 168 to expansion module 310, at a time when AI agent 160 is not engaged in a session with end user 305, periodically after each expiration of a time interval (e.g., daily, weekly, monthly, etc.), and/or in response to another trigger, such as a user operation by an administrative user 365, a system event, and/or the like.

In an alternative embodiment, base guardrail(s) 168A may be provided to expansion module 310 indirectly by an intermediate software entity. The intermediate software entity may be server application 112. Alternatively, the intermediate software entity may be a development tool that is used to generate guardrails for AI agent 160 while AI agent 160 is under development (e.g., in a design phase before deployment). In this case, expansion module 310 may operate to expand base guardrail(s) 168A, even when AI agent 160 is offline, undeployed, and/or under development.

Base guardrail(s) 168A may comprise one or more levels of guardrails. In particular, guardrails may be defined at a plurality of levels, including an agent level that is specific to AI agent 160, a user level that is specific to an end user, an organization level that is specific to an organization, a system level that is global for the entire platform 110, and/or the like. In an embodiment, base guardrails 168A comprise at least agent-level and system-level guardrails. Alternatively, base guardrails 168A may comprise only agent-level guardrails or only system-level guardrails.

Expansion module 310 may receive base guardrail(s) 168A of AI agent 160. Each base guardrail 168A may comprise one or more base guardrail elements. In particular, a base guardrail 168A may comprise one or more rules that each comprises one or more criteria, and potentially an action to be performed when the one or more criteria of the rule are satisfied. In this case, each criterion of each rule may be a guardrail element of the base guardrail 168A. For instance, a base guardrail 168A that represents a filter of an input or output may comprise one or more rules that detects the presence of a word or set of words (e.g., phrase). In this case, the base guardrail element(s) may comprise each word or set of words in each rule.

Semantic-analysis engine 320 of expansion module 310 may identify one or more similar guardrail elements that are each semantically similar, according to a similarity metric, to at least one of the base guardrail elements of base guardrail(s) 168A. Semantic-analysis engine 320 may utilize natural-language processing (NLP) and/or machine-learning models to understand the semantic relationships between words (e.g., single words, or sets of words, such as phrases, clauses, etc.) in base guardrail(s) 168A, and employ one or a plurality of techniques, such as word embeddings, ontology mapping, and/or synonym analysis, to identify similar guardrail element(s).

In an embodiment, semantic-analysis engine 320 identifies similar guardrail elements using embeddings (e.g., word embeddings). In this case, semantic-analysis engine 320 may, for each base guardrail element in base guardrail(s) 168A, convert the base guardrail element into an input embedding vector, search vector database 325 for one or more matching reference embedding vectors that are semantically similar, according to a similarity metric, to the input embedding vector, and identify each guardrail element that is associated with one of the matching reference embedding vector(s) as a similar guardrail element.

Vector database 325 may store reference embedding vectors for a plurality of historical or existing guardrail elements. In particular, existing guardrail elements may be collected for all AI agents 160 or a subset of trusted AI agents 160 executing within computing environment 150. It should be understood that there may be hundreds, thousands, millions, or billions of AI agents 160, such that there may be a diverse set of hundreds, thousands, millions, billions, or trillions of existing guardrail elements available within computing environment 150. Each guardrail element, which may comprise or consist of text, may be converted into a reference embedding vector within a common vector space, using an embedding model, and stored in vector database 325. Any suitable embedding model may be used, including, without limitation, Word2Vec, Global Vectors for Word Representation (GloVe), FastText, Embeddings from Language Models (ELMo), Bidirectional Encoder Representations from Transformers (BERT), Dense Passage Retrieval (DPR), Universal Sentence Encoder (USE), or the like. Each embedding vector represents the existing guardrail element as a vector of real numbers, with each real number in the embedding vector representing a semantic position of the guardrail element in one dimension of the vector space. The vector space is generally highly dimensional, with at least one hundred, and typically hundreds of, dimensions.

Similarly, each base guardrail element may be converted into an input embedding vector within the same common vector space, using the same embedding model. As a whole, each reference embedding vector represents the position of the respective guardrail element within the vector space, with a pair of embedding vectors that are positioned closer to each other, within the vector space, being more semantically similar than a pair of embedding vectors that are positioned farther from each other within the vector space. The similarity between a pair of embedding vectors may be determined using any suitable similarity metric based, for example, on a distance between the pair of embedding vectors (e.g., Euclidean distance, Manhattan distance, cosine distance, Hamming distance, Minkowski distance, Chebyshev distance, Jaccard distance, Haversine distance, Sorensen-Dice distance, etc.). For example, the similarity metric may be a cosine similarity, in which the cosine similarity is equal to one minus the cosine distance between the pair of embedding vectors.

Semantic-analysis engine 320 may search vector database 325 for reference embedding vectors (e.g., representing existing guardrail elements) that are similar to the input embedding vector (e.g., representing a base guardrail element), according to the similarity metric. The search may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search (FAISS), Approximate Nearest Neighbors Oh Yeah (ANNOY), scalable nearest neighbors (ScaNN), etc.), Hierarchical Navigable Small World (HNSW) graphs, Inverted File Indexing (IVF), Voronoi diagrams, vector quantization, product quantization (PQ), random projection trees, lattice-based methods (e.g., cover tree, vantage point tree, etc.), and/or the like. Semantic-analysis engine 320 may identify, as semantically similar guardrail elements which are candidates for utilization in new guardrails, one or more existing guardrail elements for which the reference embedding vector(s) are sufficiently close to the input embedding vector, according to the similarity metric. For example, any reference embedding vector that is within a predefined distance (e.g., satisfying a similarity threshold) from the input embedding vector may be identified as a matching reference embedding vector, and/or a certain number of reference embedding vectors that are closest to the input embedding vector may be identified as matching reference embedding vector(s). Once a set of matching reference embedding vector(s) have been identified, within vector database 325, the existing guardrail elements that are associated with the matching reference embedding vector(s) may be identified (e.g., retrieved).

Alternatively or additionally, semantic-analysis engine 320 may use techniques other than vector embeddings to identify guardrail elements that are semantically similar to each base guardrail element. For example, semantic-analysis engine 320 may utilize ontology mapping, which may map the base guardrail element, in one domain, to existing guardrail elements in other domains. As another example, semantic-analysis engine 320 may, when a base guardrail element is a word or set of words, retrieve synonyms for the word(s) from a software thesaurus.

In any case, whether one technique is used or a plurality of techniques are used, semantic-analysis engine 320 may output a plurality of similar guardrail elements that are semantically similar to the base guardrail elements. Regardless of the source(s) of the similar guardrail elements, in the event that the guardrail elements are words, the similar guardrail elements will include synonyms, near synonyms, contextual variants, slang, and/or euphemisms for those words.

Semantic-analysis engine 320 may generate a semantic network for each base guardrail element. The semantic network for a given base guardrail element may comprise a plurality of nodes, representing respective guardrail elements, and edges, representing relationships between guardrail elements, that connect pairs of nodes within the plurality of nodes. The semantic network may represent the base guardrail element as a hub node, with connected nodes, representing similar guardrail elements that are semantically similar to the base guardrail element, radiating outwards from the hub node. For instance, if a base guardrail element is the word “self-harm,” a hub node, representing the word “self-harm” may be connected to other nodes in the semantic network, representing the words “suicide,” “unalive,” “hurt myself,” “end it,” and the like.

Semantic-analysis engine 320 may support multiple languages and domain-specific terminology. For example, in an embodiment that utilizes embeddings, the embedding model may be trained to generate embedding vectors for words in multiple languages and/or specific domains. In an embodiment that utilizes ontology mapping and/or synonym analysis (e.g., software thesaurus), the ontology mapping and/or synonym analysis may be configured to identify similar guardrail elements in multiple supported languages and/or multiple domains. The embedding model, ontology mapping, and/or synonym analysis may be fine-tuned with enterprise-specific corpora for an organization, to improve the relevance of the similar guardrail elements to that particular organization.

Context-evaluation module 330 may generate one or more context markers based on one or more contexts that are applicable to base guardrail(s) 168A. Whereas semantic-analysis engine 320 analyzes individual guardrail elements, context-evaluation module 330 evaluates the guardrail elements within the surrounding context. The surrounding context may comprise surrounding text, a conversation history, a user intent, a document type, and/or the like. Word(s) or other guardrail elements that are appropriate in one context may be inappropriate in another context. For instance, the word “kill” is appropriate in the context of “kill process ABC,” but is inappropriate in the context of “I want to kill someone.” Thus, context-evaluation module 330 may analyze the contexts in which a guardrail element, such as word(s), is used, in order to determine the appropriateness of each guardrail element in each of one or more contexts. Context-evaluation module 330 may, for each of at least a subset of the similar guardrail elements identified by semantic-analysis module 320, generate a context marker for each of one or more, and potentially a plurality of, contexts for that similar guardrail element.

Context-evaluation module 330 may, for each of the similar guardrail elements, output by semantic-analysis engine 320, generate one or more context markers. In an embodiment, the context that is evaluated by context-evaluation module 330 comprises the context in the base guardrail 168A that contains the base guardrail element to which the similar guardrail element was matched. Each context marker may represent a context in which the respective guardrail element is not appropriate, or a context in which the respective guardrail element is appropriate. Using the above example, the context marker may indicate that the guardrail element “kill” is not appropriate in the context of a human, or is only appropriate in the context of a software entity. Thus, a context marker distinguishes between harmless and harmful uses of potentially ambiguous guardrail elements.

Context-evaluation module 330 may maintain a library of contexts. The library may comprise or consist of contexts for common enterprise scenarios. For example, the library may comprise industry-specific contexts across which guardrail elements may have different implications. Context-evaluation module 330 may generate context markers for one or more of the similar guardrail elements for each of at least a subset, and potentially all, of the contexts in the library, and/or for each of one or more groups of contexts in the library.

Context-evaluation module 330 may employ sentiment analysis to evaluate the emotional tone and potential harm of the similar guardrail elements within a given context. For example, context-evaluation module 330 may, for each similar guardrail element, for each of one or more contexts and potentially a plurality of contexts, determine a sentiment of the similar guardrail element in the context, and determine whether or not the similar guardrail element is appropriate for the context based on the determined sentiment. These context(s) may comprise the context of the base guardrail element to which the similar guardrail element was matched as semantically similar, one or more contexts that are applicable to AI agent 160, and/or one or more contexts retrieved from the library of contexts, including potentially all of the contexts in the library of contexts. In an embodiment in which guardrail expansion occurs in real-time, during a session between AI agent 160 and an end user 305, the context may alternatively or additionally comprise the context of the session. The context of the session may comprise or consist of the current context window stored in the local memory of AI agent 160 for the session.

The sentiment may be represented as a classification, from among a plurality of possible classifications. In this case, one or a subset of the classifications may be associated with appropriateness of the respective guardrail element in the respective context, whereas another one or subset of the classifications may be associated with inappropriateness of the respective guardrail element in the respective context. Alternatively, the sentiment may be represented as a numerical value within a continuous interval (e.g., zero to one). In this case, a numerical value that satisfies (e.g., is greater than, greater than or equal to, less than, or less than or equal to) a threshold may represent that the respective guardrail element is appropriate for the respective context, whereas a numerical value that does not satisfy (e.g., is less than or equal to, less than, greater than or equal to, or greater than) the threshold may represent that the respective guardrail element is inappropriate for the respective context. Any suitable algorithm may be used to determine the sentiment for a given guardrail element and context, including, without limitation, a Naïve Bayes Classifier, Support Vector Machine (SVM), a logistic regression, a recurrent neural network (RNN) (e.g., with long short-term memory (LSTM), gated recurrent unit (GRU), etc.), a convolutional neural network (CNN), a transformer-based model, such as the Bidirectional Encoder Representations from Transformers (BERT) model or any variant thereof, a lexicon-based model, and/or the like.

Dynamic-rule generator 340 may generate one or more new guardrails 168 based on the one or more similar guardrail elements, identified by semantic-analysis engine 320, and the one or more context markers, generated by context-evaluation module 330, for each similar guardrail element. As a common example, the new guardrail may comprise a new filtering rule that is generated by combining a guardrail element, such as word(s), with a context marker, representing a context in which the word(s) are inappropriate. In this case, the new filtering rule will be activated whenever the word(s) are detected within that context. Thus, a new guardrail may comprise context-dependent conditional rules (e.g., word(s) X are only filtered in context(s) Y). Dynamic-rule generator 340 may generate the new guardrail(s) 168 by, for each of at least a subset of the similar guardrail elements identified by semantic-analysis engine 320, generating a new rule that combines the similar guardrail element with a context marker that was generated by context-evaluation module 330.

New filtering rules may employ both simple matching (i.e., identifying exact matches) and fuzzy matching (e.g., identifying inexact matches) to the respective guardrail element, when appropriate in the applicable context. Fuzzy matching is a technique that identifies character strings that are approximately similar, rather than exactly identical, to find matches even with variations such as typographical errors, abbreviations, and different spellings. In an embodiment, the new filtering rules may employ regular expressions for pattern-based matching.

Dynamic-rule generator 340 may implement configurable confidence thresholds for rule generation. For example, each similar guardrail element may be associated with a confidence value, representing the probability that the guardrail element is truly semantically similar to the respective base guardrail element. Additionally or alternatively, each context marker may be associated with a confidence value, representing the probability that the context marker should be associated with the respective guardrail element. Dynamic-rule generator 340 may compute a confidence value for a rule that is defined by one or more guardrail element(s) and/or one or more context markers, based on the confidence value(s) associated with the guardrail element(s) and/or context marker(s), and then compare the computed confidence value to a confidence threshold. When the computed confidence value satisfies (e.g., is greater than or equal to) the confidence threshold, dynamic-rule generator 340 may generate a new rule comprising the guardrail element(s) and/or context marker(s). Conversely, when the computed confidence value does not satisfy (e.g., is less than) the confidence threshold, dynamic-rule generator 340 may refrain from generating or otherwise disregard a new rule comprising the guardrail element(s) and/or context marker(s). In this manner, new rules are only generated when there is sufficient confidence, as represented by the confidence threshold, for the appropriateness of the rule. The confidence threshold may be configurable by an administrative user 365. It should be understood that a lower value for the confidence threshold will result in more rules being generated by dynamic-rule generator 340 for each base guardrail element, whereas a higher value for the confidence threshold will result in fewer rules being generated by dynamic-rule generator 340 for each base guardrail element.

Dynamic-rule generator 340 may assign priority levels to different types of newly generated rules for conflict resolution. The priority level for each new rule may be based on one or more factors, such as a priority level of the base guardrail 168A from which the new rule was derived, a severity of the base guardrail element from which the new rule was derived, a severity of similar guardrail element(s) in the new rule, the confidence value computed for the new rule, a domain of AI agent 160, and/or the like. When two rules conflict, such that the two rules cannot both be activated at the same time, the rule with the highest priority level will be activated, while the rule with the lowest priority will not be activated.

Dynamic-rule generator 340 may return one or more expanded guardrails 168B that comprise the new guardrail(s) 168 generated by dynamic-rule generator 340. It should be understood that the new guardrail(s) 168 will include all of the new rule(s) that were generated by dynamic-rule generator 340. Expanded guardrail(s) 168B may comprise only the new guardrail(s) 168, in which case AI agent 160 may incorporate the new guardrail(s) 168 into base guardrail(s) 168A. Alternatively expanded guardrails 168B may comprise both the new guardrail(s) 168 and base guardrail(s) 168A. In some cases, a new guardrail 168 may represent a modification or substitution of a base guardrail 168A.

It is generally contemplated that the guardrail elements will comprise or consist of words. In this case, the presence of the words will activate corresponding guardrails 168. Thus, when a base guardrail element comprises one or more first words, the similar guardrail elements that are identified for that base guardrail element will comprise one or more second words that are different from the first word(s), but which are semantically similar, including potentially semantically identical, to the first word(s). The new guardrail(s) 168 that are generated from the base guardrail element may comprise a rule that activates that new guardrail when the second word(s) are present within an input to AI agent 160 and/or an output from AI agent 160.

At a high level, expansion module 310 identifies one or more similar guardrail elements by, for each of the one or more base guardrail elements, identifying one or more similar guardrail elements that are each semantically similar, according to a similarity metric, to that base guardrail element, via semantic-analysis engine 320. Then, expansion module 310 generates the one or more context markers by, for each of the base guardrail element(s), generating one or more context markers based on one or more contexts that are applicable to that base guardrail element, via context-evaluation module 330. Finally, expansion module 310 may generate one or more new guardrails 168 by combining each of the one or more similar guardrail elements with at least one of the one or more context markers, to generate a new filtering rule that is added to expanded guardrails 168B.

Expanded guardrail(s) 168B may be incorporated into AI agent 160. In an embodiment, human confirmation may be required for incorporation of expanded guardrail(s) 168B into AI agent 160. In particular, an administrative user 365 may be notified of expanded guardrail(s) 168B, for instance, via a dashboard of a graphical user interface of user interface 115 or administration interface 360. The dashboard may comprise one or more inputs for approving the incorporation of expanded guardrail(s) 168B into AI agent 160 and/or disapproving the incorporation of expanded guardrail(s) 168B into AI agent 160. In this case, approval by administrative user 365 will result in the incorporation of expanded guardrail(s) 168B into AI agent 160, whereas disapproval by administrative user 365 will result in expanded guardrail(s) 168B being disregarded or otherwise not incorporated into AI agent 160. Administrative user 365 may be a manager or developer of AI agent 160. In an alternative embodiment, expanded guardrail(s) 168B may be incorporated into AI agent 160 automatically, without any human involvement.

Expanded guardrail(s) 168B may also be stored in expansion database 345, in association with base guardrail(s) 168A. Expansion database 345 may be distributed across multiple server nodes (e.g., of a cloud-computing environment) for high availability within computing environment 150. It should be understood that the guardrails of a given AI agent 160 may be expanded multiple times over multiple iterations of expansion module 310. For each of a plurality of AI agents 160 in computing environment 150, the original base guardrail(s) 168A and each set of expanded guardrail(s) 168B may be stored, in association with an identifier (e.g., unique identifier) of that AI agent 160, within expansion database 345. Thus, expansion database 345 may store each version of guardrails 168 for each AI agent 160 within computing environment 150.

Expansion database 345 may provide version control for the guardrails 168 of each AI agent 160. In particular, expansion database 345 may maintain the relationships between each set of guardrails 168, including base guardrail(s) 168A and expanded guardrail(s) 168B, and each AI agent 160. This enables the guardrails 168 for a given AI agent 160 to be rolled back if necessary. For example, when there are issues after an expansion of the guardrails 168 of AI agent 160, such as a degradation in the compliance and/or performance of AI agent 160, a prior version of the guardrails 168 (e.g., either the original base guardrail(s) 168A or preceding expanded guardrail(s) 168B) may be retrieved from expansion database 345 and used to replace the existing guardrails 168 of AI agent 160, to thereby roll back the guardrails 168 to a prior version. It should be understood that the prior version of the guardrails 168 may represent guardrails 168 with which AI agent 160 performed in a suitable compliant manner.

Expansion database 345 enables the provenance of expanded guardrail(s) 168B to be tracked for auditing purposes. For example, the entire evolution of the guardrails 168 for an AI agent 160, including every expansion of the guardrails 168, from the original base guardrail(s) 168A to the latest expanded guardrail(s) 168B, may be reviewed and/or analyzed. Expansion database 345 may be indexed by the identifier of AI agents 160, and may provide efficient query mechanisms for real-time retrieval of any version of the guardrails 168 for a given AI agent 160.

Analysis engine 350 may analyze the guardrails 168 of AI agents 160, stored within expansion database 345. For example, analysis engine 350 may monitor the evolution of the language used in guardrails 168, and identify trends in that language over time. Based on this monitoring, analysis engine 350 may identify emerging terms and expressions to be included in state-of-the-art guardrails 168.

Analysis engine 350 may also analyze data from other data sources, such as historical data for executions of AI agents 160. The historical data may comprise inputs to AI agents 160, activations of guardrails 168, examples of false positives, examples of false negatives, and/or the like. From the historical data, analysis engine 350 may detect attempts to circumvent guardrails 168 through novel phrasing. For example, analysis engine 350 may parse inputs that are associated with successive activations of guardrails 168 and/or false negatives to extract common terms being used in attempts to circumvent guardrails 168.

Analysis engine 350 may analyze the frequency and/or context of terms across different segments of end users 305. End users 305 may be segmented by role, industry, geographical region, and/or any other dimension. By analyzing the frequency distributions and contextual usage between different user segments, analysis engine 350 can identify terms that are distinctive for certain dimensions and/or are appropriate in certain contexts. Analysis engine 350 may convert such terms into new reference embedding vectors, using the embedding model, and add these new reference embedding vectors to vector database 325, in association with their respective terms as new reference guardrail elements. Additionally or alternatively, analysis engine 350 may use this information to improve the ability of context-evaluation module 330 to identify contexts in which the terms are appropriate and/or inappropriate, for example, by fine-tuning the sentiment analysis used by context-evaluation module 330 using the new terms and their respective contexts.

Analysis engine 350 may provide early warning of potential new areas that may require guardrails 168. For instance, analysis engine 350 may continuously monitor trends in the language being used by end users 305 and identify patterns associated with risky or policy-relevant content. When a new pattern (e.g., novel terms, phrases, euphemisms, contextual shifts, etc.) begins to appear with increasing frequency, analysis engine 350 may flag the pattern for review (e.g., by administrative user 365) before the pattern becomes more widespread. Administrative user 365 may evaluate each flagged pattern and, when appropriate, construct one or more new guardrails 168 designed to activate when the pattern is detected (e.g., in an input or output) during the execution of one or more AI agents 160. This proactive guardrail management enables administrative users 365 to anticipate and address potential misuse or safety gaps early, to ensure that guardrail coverage evolves in step with changing language and user behavior. This is in contrast to conventional systems which are limited to reactive guardrail management.

Administrative user 365 may interact with an administration interface 360 to manage guardrail manager 116. Administration interface 360 may receive (e.g., retrieve, collect, etc.) the results of analysis engine 350, and present the analytic results to administrative user 365 in a graphical user interface. Administrative user 365 may review the analytic results in the graphical user interface, interact with the analytic results via one or more inputs in the graphical user interface, approve updates to vector database 325 and/or expansion module 310 based on the analytic results, and/or the like.

Administration interface 360 may provide visualization of semantic relationships between terms, representing potential new guardrail elements to be embedded into the vector space of vector database 325. In particular, administration interface 360 may generate a graphical user interface that includes a visualization of a semantic network for any given guardrail element. The semantic network for the guardrail element may be visually represented as a plurality of nodes, with a node representing the guardrail element acting as a hub for the other nodes, which represent semantically similar guardrail elements. The nodes are connected by edges that represent relationships between the guardrail elements within the semantic network. It should be understood that the guardrail elements may represent terms used or to potentially be used in filtering rules of guardrails 168. Administrative user 365 may explore the visualization of the semantic network to easily understand how expansion module 310 and/or vector database 325 group related concepts, identify gaps or misclassifications, refine guardrail definitions, and/or the like. This transparency supports oversight of automated guardrail expansion and facilitates the efficient management of complex language models.

Administration interface 360 may allow manual review and adjustment of expanded guardrails 168B, prior to incorporation into respective AI agents 160. Administration interface 360 may generate a graphical user interface that visually represents the origin of each guardrail 168B (e.g., the base guardrail 168A from which guardrail 168B was derived), the process resulting in each guardrail 168B (e.g., confidence value(s) computed for the component element(s) of guardrail 168B, the semantic network for the guardrail element(s) of guardrail 168B, etc.), and/or the like. Administrative user 365 may, via one or more inputs in the graphical user interface of administration interface 360, approve expanded guardrail(s) 168B for incorporation into AI agent 160, disapprove expanded guardrail(s) 168B to prevent their incorporation into AI agent 160, modify expanded guardrail(s) 168B and initiate the incorporation of the modified expanded guardrail(s) 168B into AI agent 160, and/or the like. This human-in-the-loop process may ensure that automated guardrail expansion remains accurate and compliant with an organization's standards.

Administration interface 360 may support bulk operations for guardrail management. For example, administrative user 365 may utilize the graphical user interface of administration interface 360 to quickly approve, disapprove, and/or modify batches of expanded guardrails 168B in bulk. In addition, administrative user 365 may utilize the graphical user interface to simultaneously incorporate one or more guardrails 168B into a plurality of AI agents 160, for instance, by selecting one or more AI agents 160 from a registry or list of available AI agents 160 and then selecting a single input or single sequence of inputs within the graphical user interface. Thus, administrative user 365 may quickly and easily deploy expanded guardrail(s) 168B to a plurality of related AI agents 160 using a single user operation.

Administration interface 360 may comprise testing tools to validate the effectiveness of guardrails 168. For instance, a testing tool may instantiate an AI agent 160 into a sandbox of a test environment, in which AI agent 160 is not able to affect production data, and run each of a plurality of test scenarios on the AI agent 160 while the AI agent 160 executes in the sandbox. The plurality of test scenarios may submit both compliant and non-compliant inputs to AI agent 160, and the decision-making process of AI agent 160, including any guardrail activations, may be presented to administrative user 365 in the graphical user interface of administration interface 360 and/or analyzed to generate one or more compliance metrics (e.g., number or rate of false positives, number or rate of false negatives, precision, recall, etc.) representing how well guardrails 168 performed. Each test scenario may identify whether or not a guardrail 168 should have been activated, such that the compliance metrics, potentially including false positives and false negatives, may be easily calculated. Such tools allow administrative user 365 to run controlled evaluations using both compliant and non-compliant examples, verifying that harmful or prohibited terms are correctly flagged while legitimate content remains unaffected, and enables administrative user 365 to fine-tune guardrails 168, including thresholds and rule configurations (e.g., guardrail elements and/or context markers). This validation process ensures that guardrails 168 of AI agents 160 operate reliably before deployment in production environments.

Administration interface 360 may provide a dashboard that comprises performance metrics for guardrails 168. In particular, a dashboard in the graphical user interface of administration interface 360 may comprise the value for each of one or more performance metrics, related to guardrails 168, for each of one or more AI agents 160 for which administrative user 365 is responsible. The performance metric(s) may be provided in real time as AI agents 160 execute in a test environment or production environment of computing environment 150. The performance metric(s) may include key performance indicators (KPIs), such as detection accuracy, number or rate of false positives, number or rate of false negatives, frequency of guardrail activations, and/or the like. The dashboard may also graphically represent trends in one or more performance metrics over time. The dashboard may comprise one or more inputs for filtering the performance metrics by language, user segment, and/or the like, to identify specific areas needing improvement. By consolidating performance data into clear visual summaries, the dashboard enables informed decision-making, faster troubleshooting, and continuous optimization of guardrails 168.

Administration interface 360 may enable role-based access control for security management, to ensure that only authorized administrative users 365 can view, modify, or deploy guardrails 168. Access permissions may be assigned based on user roles (e.g., administrator, reviewer, or auditor), which each have defined levels of control and visibility. This prevents unauthorized changes to critical guardrails 168 while maintaining operational flexibility for different teams. Role-based access also supports compliance with enterprise security policies by enforcing accountability, tracking actions of administrative users 365, and maintaining detailed audit logs of all guardrail management activities.

Feedback-incorporation module 370 may receive feedback 375 from end users 305, and incorporate the received feedback 375 into updates to expansion module 310 and/or vector database 325. At a high level, feedback-incorporation module 370 may receive feedback 375 for at least one interaction between AI agent 160 and end user 305, and update one or more of semantic-analysis engine 320, context-evaluation module 330, or dynamic-rule generator 340, based on feedback 375. Feedback-incorporation module 370 may determine one or more false positives and/or one or more false negatives based on feedback 375, in which case, the update to semantic-analysis engine 320, context-evaluation module 330, and/or dynamic-rule generator 340 may be based on the false positive(s) and/or false negative(s). A false positive represents an activation of at least one of expanded guardrail(s) 168B when that at least one expanded guardrail 168B should not have been activated, whereas a false negative represents a failure to activate any of expanded guardrail(s) 168B when at least one of expanded guardrail(s) 168B should have been activated.

Feedback 375 may be received directly from end users 305 and/or indirectly from end users 305 via AI agent 160. Feedback 375 may comprise a positive indicator representing positive feedback for an output of AI agent 160 (e.g., representing that end user 305 selected a thumbs-up or other positive-feedback input), a negative indicator representing negative feedback for an output by AI agent 160 (e.g., representing that end user 305 selected a thumbs-down or other negative-feedback input), natural-language feedback from end user 305 (e.g., which may represent negative, neutral, or positive feedback), a numerical feedback score representing a degree of positivity or negativity to an output of AI agent 160 (e.g., generated by a feedback-scoring model, such as a semantic-analysis algorithm, that generates a feedback score from natural-language feedback from end user 305), and/or the like.

Feedback-incorporation module 370 may collect feedback 375 from both successful and failed applications of guardrails 168 for each of one or more AI agents 160. Each application, whether guardrail(s) 168 correctly intercepted harmful content or missed a violation, may be logged with contextual data. Feedback-incorporation module 370 may use these false positives and false negatives to evaluate the real-world performance of AI agent(s) 160 and refine guardrails 168 of AI agent(s) 160 for future operations. This feedback loop provides continuous improvement of guardrails 168 over time.

Feedback-incorporation module 370 may update the semantic networks, used to generate expanded guardrails 168B, based on the operational performance of one or more AI agents 160. For example, the semantic networks for base guardrail elements may be maintained (e.g., in expansion database 345) and periodically updated using data from real-world operations of AI agents 160, to incorporate new language patterns, terminology, and context variations observed during guardrail enforcement. Performance metrics may guide these updates, ensuring the semantic networks remain aligned with current trends. This adaptive retraining of the semantic networks keeps guardrails 168 accurate and relevant, even as language evolves.

Feedback-incorporation module 370 may process feedback from human moderators to refine the semantic networks between guardrail elements in vector database 325. In particular, administrative user 365 may review the semantic networks that were generated for base guardrail elements, by semantic-analysis engine 320, within the graphical user interface of administration interface 360, and modify the semantic network, as needed, via one or more inputs of the graphical user interface, to correct or enhance the understanding of semantic relationships by expansion module 310. This feedback may help expansion module 310 distinguish between nuanced meanings, idiomatic expressions, or context-dependent phrases that expansion module 310 may have originally misinterpreted. These manual refinements may be incorporated into the semantic networks used to generate expanded guardrails 168B, to improve the quality and reliability of future guardrail expansions.

Feedback-incorporation module 370 may identify false positives and false negatives in the application of guardrails 168 for each of one or more AI agents 160, and use this information to improve the accuracy of guardrails 168 for AI agent(s) 160. For example, feedback 375 may comprise, for each of one or more interactions with an AI agent 160, the input that was received by AI agent 160 from end user 305, an indication of each guardrail 168 that was activated or an indication that no guardrails 168 were activated, and/or the output that was generated by AI agent 160. Feedback-incorporation module 370 may, for each interaction, analyze the inputs, outputs, and activations, if any, to determine whether or not the interaction represents a false positive or false negative. Feedback-incorporation module 370 may utilize the false positives and/or false negatives to update one or more parameters (e.g., weights, thresholds, etc.) of expansion module 310, such as any of the algorithms of semantic-analysis engine 320, context-evaluation module 330, and/or dynamic-rule generator 340. As an example of an update to semantic-analysis engine 320, the similarity threshold for determining when the similarity metric between an input embedding vector and a reference embedding vector is sufficiently high to consider the reference embedding vector as a match to the input embedding vector may be adjusted (e.g., higher if the new rules being generated are too expansive, or lower if the new rules being generated are too narrow). As another example, the confidence thresholds that are used, for example, by dynamic-rule generator 340, to determine whether or not the confidence value of a guardrail element and/or context marker is sufficient to justify incorporation of that guardrail element and/or context marker into a new rule may be adjusted (e.g., higher if the new rules being generated are too expansive, or lower if the new rules being generated are too narrow).

Feedback-incorporation module 370 may generate reports on the effectiveness of guardrails 168 for one or more AI agents 160, and/or opportunities for improving the effectiveness of guardrails 168 for one or more AI agents 160. These reports may be provided to administrative user 365 via the graphical user interface of administration interface 360. The reports may summarize the performance of guardrails 168, for one or more AI agents 160 for which administrative user 365 is responsible, including performance metrics and trends. The report may also identify areas with low performance, indicating areas in need of improvement. The reports provide actionable insights for administrative users 365, highlighting which guardrails 168 perform well and which guardrails 168 require review. Regular reporting supports data-driven decision-making and strategic planning for optimization of guardrails 168.

Feedback-incorporation module 370 may support active learning by expansion module 310, to continually improve the performance of expansion module 310 over time. For example, expansion module 310 may be selectively retrained on new and uncertain scenarios. When ambiguous cases are identified, they may be prioritized for human review, and the corrected results may be input into the training process. This ongoing feedback cycle enables expansion module 310 to learn efficiently from real-world data and adapt to evolving usage patterns without requiring retraining from scratch.

### 4. Process

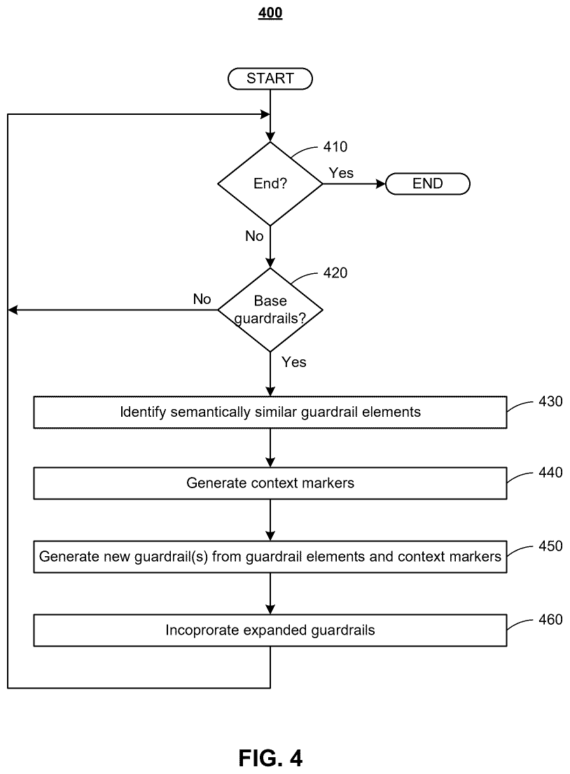

FIG. 4 illustrates an example process 400 for dynamic and adaptive semantic guardrail expansion for AI agents 160, according to an embodiment. Process 400 may be implemented by guardrail manager 116, and specifically, expansion module 310 of guardrail manager 116. Process 400 may be executed for each of one or more AI agents 160, and generally for each of a plurality of AI agents 160.

While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Process 400 may continue for as long as expansion module 310 is operational. In this case, subprocess 410 may determine to end process 400 when the operation of expansion module 310 is terminated. The operation of expansion module 310 may be terminated in response to an operation by a user (e.g., a user selection of an input within a graphical user interface of user interface 115), in response to an instruction from another software entity (e.g., server application 112), as a result of a failure in expansion module 310 or other component of platform 110, and/or the like. When determining to end process 400 (i.e., “Yes” in subprocess 410), process 400 may end. Otherwise, when not determining to end process 400 (i.e., “No” in subprocess 410), process 400 may proceed to subprocess 420.

Subprocess 420, which may be implemented by semantic-analysis engine 320, may determine whether or not a new set of one or more base guardrails 168A of an AI agent 160 has been received. Each base guardrail 168A may comprise one or more base guardrail elements. It is generally contemplated that a base guardrail element would be a single word or set of words (e.g., phrase, clause, etc.). However, a guardrail element could potentially be some other component of a base guardrail 168A. A single base guardrail 168A may comprise one base guardrail element or a plurality of base guardrail elements. When receiving one or more base guardrails 168A (i.e., “Yes” in subprocess 420), process 400 may proceed to subprocess 430. Otherwise, while not receiving any base guardrails 168A (i.e., “No” in subprocess 420), process 400 may return to subprocess 410.

Subprocess 430, which may be implemented by semantic-analysis engine 320, may identify one or more similar guardrail elements that are each semantically similar, according to a similarity metric, to at least one of the one or more base guardrail elements of base guardrail(s) 168A. The similar guardrail element(s) may be identified by, for each of the one or more base guardrail elements, converting the base guardrail element into an input embedding vector, searching vector database 325 for one or more matching reference embedding vectors that are semantically similar, according to the similarity metric, to the input embedding vector, and identifying each guardrail element that is associated with one of the one or more matching reference embedding vectors as one of the similar guardrail element(s) output by subprocess 430. More generally, subprocess 430 may comprise, for each of the base guardrail elements, identifying one or more similar guardrail elements that are each semantically similar, according to the similarity metric, to that base guardrail element. Alternatively or additionally, subprocess 430 may utilize ontology mapping and/or synonym analysis.

Subprocess 440, which may be implemented by context-evaluation module 330, may generate one or more context markers based on one or more contexts that are applicable to AI agent 160. Subprocess 440 may comprise for each of the similar guardrail element(s), output by subprocess 430, and for each of one or more contexts and potentially a plurality of contexts, determining a sentiment of the similar guardrail element within the context, and determining whether or not the similar guardrail element is appropriate for the context based on the determined sentiment. More generally, subprocess 440 may comprise, for each of the similar guardrail element(s), generating a context marker for each of the context(s) for that similar guardrail element.

The context(s), for which the context marker(s) are generated, may comprise a context of the at least one base guardrail element to which the similar guardrail element is semantically similar, a context retrieved from a library of contexts, and/or the like. In the event that process 400 is being performed in real time, during a session between AI agent 160 and end user 305, the context(s) may comprise or consist of the current context window of AI agent 160 from the session.

Subprocess 450, which may be implemented by dynamic-rule generator 340, may generate one or more new guardrails based on the similar guardrail elements, identified by subprocess 430, and the context marker(s) generated by subprocess 440. Subprocess 450 may comprise, for each of at least a subset of the similar guardrail elements and potentially all of the similar guardrail elements, generating a rule that combines the similar guardrail element with at least one of the context marker(s). In other words, each similar guardrail element may be combined with at least one context marker to generate a new filtering rule. This new filtering rule may be added to a new guardrail 168, which is included in expanded guardrail(s) 168B.

Subprocess 460, which may be implemented by dynamic-rule generator 340, may incorporate expanded guardrail(s) 168, which comprise the new guardrail(s) generated by subprocess 450, into AI agent 160. This incorporation may comprise or consist of dynamic-rule generator 340 returning expanded guardrail(s) 168 to the requesting entity, which may be AI agent 160 or an intermediate software entity. Expanded guardrail(s) 168 may comprise base guardrail(s) 168A and the new guardrail(s) 168 generated by subprocess 450. Alternatively, expanded guardrail(s) 168 may consist of only the new guardrail(s) 168. The new guardrail(s) 168 may be in addition to base guardrail(s) 168A and/or may comprise a modification to each of one or more of base guardrail(s) 168A.

As an example of a new guardrail 168, the base guardrail elements may comprise one or more first keywords, and the similar guardrail elements may comprise one or more second keywords that are different from the first keyword(s) but semantically similar to the first keyword(s). At least one of the new guardrails 168 may comprise or consist of a rule that activates the at least one new guardrail 168 when the second keyword(s) are present within an input to AI agent 160 and/or an output generated by AI agent 160.

Subprocess 460 may also comprise storing base guardrail(s) 168A and expanded guardrail(s) 168B, in association with an identifier of AI agent 160, within expansion database 345. Expansion database 345 may store each version of guardrail(s) 168, before and after each expansion, for each AI agent 160 within computing environment 150. This enables expanded guardrail(s) 168B to be rolled back to respective base guardrail(s) 168A when necessary, such as in the event that there is a decrease in performance or compliance of AI agent 160 after the incorporation of expanded guardrail(s) 168B. The evolution of guardrails 168, over time, as represented in expansion database 345 may also be used by analysis engine 350 to identify trends and update expansion module 310 and/or vector database 325 based on those trends, as discussed elsewhere herein.

Base guardrail(s) 168A may be received in real time, directly from AI agent 160, as AI agent 160 is interacting with an end user 305 in a session. In this case, guardrails 168 may be dynamically expanded, in real time, during a session between end user 305 and AI agent 160. In such an embodiment, expanded guardrail(s) 168B may result in activations of guardrail(s) 168 that may not have occurred in the absence of the disclosed guardrail expansion, or the failure of activations of guardrail(s) 168 that would otherwise have occurred in the absence of the disclosed guardrail expansion. During real-time guardrail expansion, context-evaluation module 340 may utilize the actual context of the current session between AI agent 160 and end user 305 to generate the context marker(s). Thus, the guardrail expansion may account for the current context of AI agent 160.

As an example of real-time guardrail expansion, end user 305 may submit a potentially harmful input to AI agent 160 that would not activate base guardrail(s) 168A. AI agent 160 may, in real time, submit base guardrail(s) 168A to expansion module 310 of guardrail manager 116, which may return expanded guardrail(s) 168B. AI agent 160 may apply expanded guardrail(s) 168B, which may include base guardrail(s) 168A, to the input, which may activate one of the new guardrails 168 in expanded guardrails 168B. As a result of the activation, AI agent 160 may perform an associated remedial action, such as blocking the input and informing end user 305 that the input is non-compliant.

As another example of real-time guardrail expansion, end user 305 may submit an input to AI agent 160 that is not harmful in the current context, but which would activate a base guardrail 168A because the input is harmful in other contexts for which base guardrail 168A was created. In this case, AI agent 160 may, in real time, submit base guardrail(s) 168A to expansion module 310 of guardrail manager 116, which may return expanded guardrail(s) 168B. AI agent 160 may apply expanded guardrail(s) 168B, which may include a modification to base guardrail(s) 168A, to the input, in which case expanded guardrail(s) 168B may not activate as a result of the modification to base guardrail(s) 168A.

More generally, the guardrail expansion, represented by process 400, may be performed in real time during a session between AI agent 160 and an end user 305. In this case, the guardrail expansion may occur between the reception of an input by AI agent 160 from end user 305 and an application of guardrails 168 of AI agent 160 to the input, output of AI model 162, and/or decision of AI agent 160. In other words, the guardrail(s) 168 that are applied by AI agent 160 include expanded guardrail(s) 168B.

Alternatively or additionally, base guardrail(s) 168A may be received outside of a session between AI agent 160 and an end user 305, directly from AI agent 160 (e.g., assuming AI agent 160 is online) or indirectly from an intermediate software entity (e.g., a background process that periodically expands guardrails 168 for AI agents 160). In this case, context-evaluation module 340 may not have the actual context of a session between AI agent 160 and an end user 305, but may generate context marker(s) based on the context of the base guardrail elements, one or more contexts that are applicable to AI agent 160, and/or one or more contexts retrieved from a library of contexts. In any case, AI agent 160 or the intermediate software entity may incorporate expanded guardrail(s) 168 into AI agent 160, prior to the next session between AI agent 160 and an end user 305. In an embodiment, the guardrail expansion of process 400 may be performed for each AI agent 160 whenever that AI agent 160 is created or deployed, each AI agent 160 whenever that AI agent is instantiated within computing environment 150, all AI agents 160 during an initialization of computing environment 150, all AI agents 160 for a particular organization during an initialization of the organization's environment within computing environment 150, all AI agents 160 operating in computing environment 150, and/or the like.

In an embodiment, process 400 may be toggled on or off for particular AI agents 160 or groups of AI agents (e.g., all of a particular developer's or organization's AI agents 160). When process 400 is toggled off for a given AI agent 160, no expansion of guardrails 168 for that AI agent 160 will be performed. In addition, when process 400 is toggled off for a given AI agent 160, AI agent could revert to its original base guardrails 168A. This may be accomplished by rolling back guardrail(s) 168 for that AI agent 160 to the first version of guardrail(s) 168 that is stored in expansion database 345 for that AI agent 160. In this case, when process 400 is toggled on again for that AI agent 160, AI agent could revert back to its latest expanded guardrails 168B, using the latest version of guardrail(s) 168 that is stored in expansion database 345 for that AI agent 160.

It should be understood that analysis engine 350 and feedback-incorporation module 370 may operate in parallel with process 400, as implemented by expansion module 310. For example, analysis engine 350 may analyze expansion database 345 to identify trends in guardrails 168 and graphically represent identified trends to administrative users 365 in the graphical user interface of administration interface 360. In addition, feedback-incorporation module 370 may receive feedback 375 for at least one interaction between AI agent 160 and end user 305, and update one or more of semantic-analysis engine 320, context-evaluation module 330, and/or dynamic-rule generator 350, based on feedback 375. Feedback-incorporation module 370 may also determine one or both of one or more false positives or one or more false negatives based on feedback 375. Each false negative represents an activation of at least one of expanded guardrails 168B when that expanded guardrail 168B should not have been activated, whereas each false negative represents a failure to activate any of expanded guardrail(s) 168B when at least one of expanded guardrails 168B should have been activated. The update to semantic-analysis engine 320, context-evaluation module 330, and/or dynamic-rule generator 340 may be based on the false positive(s) and/or false negative(s).

### 5. Example Embodiment

Disclosed embodiments provide a guardrail manager 116 that dynamically expands and refines language-based guardrails in AI agents 160, using an analysis of semantic relationships and contextual understanding. Guardrail manager 116 may automatically identify and incorporate similar guardrail elements, such as words, phrases, and concepts, which should be subject to the same filtering rules as explicitly defined base guardrails 168A, into expanded guardrails 168B. Expanded guardrails 168B significantly enhance the effectiveness of content filtering, prompt-attack detection, and relevance checks, while reducing the need for constant manual updates of guardrails 168 in enterprise environments which may comprise hundreds, if not millions or billions, of AI agents 160 with respective guardrails 168.

Initially, guardrail manager 116 may initialize expansion module 310. Initialization of expansion module 310 may comprise importing existing guardrail elements, converting the existing guardrail elements into reference embedding vectors, and storing the reference embedding vectors in vector database 325 for use by semantic-analysis engine 320. These existing guardrail elements may represent words to be filtered, topics to be filtered, harmful content categories, and/or the like. In addition, the initialization of expansion module 310 may comprise establishing a baseline algorithm for sentiment analysis in context-evaluation module 330, building a baseline library of contexts for use by context-evaluation module 330, and/or the like. The initialization of expansion module 310 may also include configuring one or more settings (e.g., thresholds), including organization-specific settings, and defining domain-specific terminology and context parameters.

During expansion by expansion module 310, semantic-analysis engine 320 may first semantically expand base guardrail(s) 168A. In particular, semantic-analysis engine 320 may, in subprocess 430, identify guardrail elements that are semantically similar to base guardrail elements in base guardrail(s) 168A (e.g., using vector database 325, ontology mapping, synonym analysis, and/or the like). Reference guardrail elements may be filtered based on a similarity metric and configurable similarity thresholds for the similarity metric. Semantic-analysis engine 320 may generate a semantic network for each base guardrail element that relates the base guardrail element to each semantically similar guardrail element. In this manner, base guardrail elements may be grouped with semantically related reference guardrail elements into expansion clusters.

Next, context-evaluation module 330 may generate one or more context markers for each expansion cluster, in subprocess 440. Context-evaluation module 330 may also analyze how the semantically similar guardrail elements, within the expansion clusters, are used in each of one or more relevant contexts, and identify contextual patterns that distinguish between compliant and non-compliant usage of the similar guardrail elements. The context markers enable conditional application of guardrail elements to specific contexts, for the generation of context-dependent rules for ambiguous guardrail elements.

Next, dynamic-rule generator 340 may, in subprocess 450, generate new guardrails 168 based on the similar guardrail element(s), output by semantic-analysis engine 320, and the context marker(s), output by context-evaluation module 330. Essentially, dynamic-rule generator 340 converts the semantic and contextual information into operational rules representing new guardrails 168. Each newly generated rule may be associated with a confidence value and/or a priority level. Dynamic-rule generator 340 may identify conflicts between new rules and existing rules in baseline guardrail(s) 168A, and assign the priority levels to resolve each conflict, based on one or more factors. Expanded guardrail(s) 168B may be stored in expansion database 345, for utilization by analysis engine 350 and/or to provide rollback capabilities for guardrails 168.

During operation of AI agents 160, feedback-incorporation module 370 may monitor the effectiveness of guardrails 168 of AI agents 160, including base guardrails 168A and expanded guardrails 168B, and collect feedback 375 on the performance of these guardrails 168. Feedback-incorporation module 370 may log false positives and false negatives, and periodically update one or more components of expansion module 310 based on the false positives, false negatives, and/or other information derived from feedback 375.

Human feedback from administrative users 365, via administration interface 360, may be used to refine guardrails 168. In addition, analysis engine 350 may analyze expansion database 345, to identify emerging trends which may inform proactive updates to guardrails 168. These trends may inform the modification of guardrails 168 by administrative users 365. Performance metrics may also be collected for guardrails 168 (e.g., by analysis engine 350 and/or feedback-incorporation module 370) and used to adjust one or more parameters (e.g., weights, thresholds, etc.) of expansion module 310.

Advantageously, disclosed embodiments enable guardrails 168 of AI agents 160 to evolve with emerging trends, and work for both prevention (e.g., input filtering) and generation (e.g., output filtering). In addition, multi-modal context-aware expansion allows the automated and accurate differentiation between appropriate and inappropriate language. The evolution of guardrails 168 for each AI agent 160 may be preserved in expansion database 345, which enables failure recovery (e.g., rollback) and trend analysis (e.g., by analysis engine 350). Furthermore, each expansion is explainable, since the relationships between base and expanded guardrails 168 are preserved within expansion database 345, such that every new rule can be directly attributed to a base guardrail element. Feedback 375 may also be used to adjust parameters of expansion module 310, such as confidence thresholds. Disclosed embodiments also allow cross-domain transfer learning, while maintaining data isolation between organizations, and solves the cold-start problem for guardrails 168 for new AI agents 160, since a set of guardrails 168 may be imported from a similar existing AI agent 160 or data store and expanded for the particular context of each new AI agent 160.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, for each of one or more artificial intelligence (AI) agents, performing a guardrail expansion that comprises:
receiving one or more base guardrails of the AI agent, wherein each of the one or more base guardrails comprises one or more base guardrail elements;
identifying one or more similar guardrail elements that are each semantically similar, according to a similarity metric, to at least one of the one or more base guardrail elements of the one or more base guardrails;
generating one or more context markers based on one or more contexts that are applicable to the AI agent;
generating one or more new guardrails based on the one or more similar guardrail elements and the one or more context markers; and
incorporating one or more expanded guardrails that comprise the one or more new guardrails into the AI agent.

2. The method of claim 1, wherein the one or more expanded guardrails are a plurality of guardrails that comprises the one or more base guardrails and the one or more new guardrails.

3. The method of claim 1, wherein the one or more base guardrail elements comprise one or more first keywords, and wherein the one or more similar guardrail elements comprise one or more second keywords that are different from the one or more first keywords.

4. The method of claim 3, wherein at least one of the one or more new guardrails comprises a rule that activates the at least one guardrail when the one or more second keywords are present within an input to the AI agent or an output generated by the AI agent.

5. The method of claim 1, wherein identifying the one or more similar guardrail elements comprises, for each of the one or more base guardrail elements:
converting the base guardrail element into an input embedding vector;
searching a vector database for one or more matching reference embedding vectors that are semantically similar, according to the similarity metric, to the input embedding vector; and
identifying each guardrail element that is associated with one of the one or more matching reference embedding vectors as one of the one or more similar guardrail elements.

6. The method of claim 1, wherein generating the one or more context markers comprises, for each of the one or more similar guardrail elements, for each of the one or more contexts:
determining a sentiment of the similar guardrail element within the context; and
determining whether or not the similar guardrail element is appropriate for the context based on the determined sentiment.

7. The method of claim 6, wherein the one or more contexts comprise a plurality of contexts.

8. The method of claim 6, wherein, for each of the one or more similar guardrail elements, the one or more contexts comprise a context of the at least one base guardrail element to which the similar guardrail element is semantically similar.

9. The method of claim 6, wherein, for each of the one or more similar guardrail elements, the one or more contexts comprise a context retrieved from a library of contexts.

10. The method of claim 1, wherein generating the one or more context markers comprises, for each of the one or more similar guardrail elements, generating a context marker for each of the one or more contexts for that similar guardrail element.

11. The method of claim 10, wherein generating the one or more new guardrails comprises, for each of at least a subset of the one or more similar guardrail elements, generating a rule that combines the similar guardrail element with at least one of the one or more context markers.

12. The method of claim 1, further comprising using the at least one hardware processor to, for each of a plurality of AI agents, store the one or more base guardrails and the one or more expanded guardrails, in association with an identifier of the AI agent, within an expansion database.

13. The method of claim 1, wherein the identification of the one or more similar guardrail elements is performed by a semantic-analysis engine, wherein the generation of the one or more context markers is performed by a context-evaluation module, wherein the generation of the one or more new guardrails is performed by a dynamic-rule generator, and wherein the method further comprises using the at least one hardware processor to:
for each of at least a subset of the one or more AI agents, during execution of the AI agent, receive feedback for at least one interaction between the AI agent and an end user; and
update one or more of the semantic-analysis engine, context-evaluation module, or dynamic-rule generator, based on the feedback.

14. The method of claim 13, further comprising determining one or both of one or more false positives or one or more false negatives based on the feedback, wherein each of the one or more false positives represents an activation of at least one of the one or more expanded guardrails when that at least one expanded guardrail should not have been activated, wherein each of the one or more false negatives represents a failure to activate any of the one or more expanded guardrails when at least one of the one or more expanded guardrails should have been activated, and wherein the update to one or more of the semantic-analysis engine, context-evaluation module, or dynamic-rule generator is based on the one or both of the one or more false positives or the one or more false negatives.

15. The method of claim 1,
wherein identifying one or more similar guardrail elements comprises, for each of the one or more base guardrail elements, identifying one or more similar guardrail elements that are each semantically similar, according to the similarity metric, to that base guardrail element,
wherein generating the one or more context markers comprises, for each of the one or more base guardrail elements, generating one or more context markers based on one or more contexts that are applicable to that base guardrail element, and
wherein generating the one or more new guardrails comprises, combining each of the one or more similar guardrail elements with at least one of the one or more context markers, to generate a new filtering rule.

16. The method of claim 1, wherein the guardrail expansion is performed in real time during a session between the AI agent and an end user.

17. The method of claim 16, wherein the guardrail expansion occurs between a reception of an input by the AI agent from the end user and an application of guardrails of the AI agent to the input, such that the guardrails that are applied to the input include the one or more expanded guardrails.

18. The method of claim 16, wherein the one or more contexts comprise a current context window of the AI agent from the session.

19. A system comprising:
at least one hardware processor; and
software that is configured to, when executed by the at least one hardware processor, perform the method of claim 1.

20. A non-transitory computer-readable medium having instructions stored therein, wherein the instructions, when executed by a processor, cause the processor to perform the method of claim 1.
